(19) United States
(12) Patent Application Publication
(10) Pub. No.: US 2026/0316617 A1
(43) Pub. Date: Oct. 15, 2026

(54) Multi-Application Scenario-Oriented Method and System for Regulating Electric Automobile Charging Loads

(71) Applicant: Electric Power Research Institute of Hainan Power Grid Co., Ltd., Haikou (CN)

(72) Inventors: Songling PANG, Haikou (CN); Kaidi FAN, Haikou (CN); Chao CHEN, Haikou (CN); Jie DOU, Haikou (CN); Wangcheng ZHU, Haikou (CN); Hailong ZHAO, Haikou (CN)

(21) Appl. No.: 19/665,463

(22) Filed: May 1, 2026

Related U.S. Application Data
(63) Continuation of application No. PCT/CN2024/104107, filed on Jul. 6, 2024.

(30) Foreign Application Priority Data
Dec. 26, 2023 (CN) 202311810387.2

(51) Int. Cl. B60L 53/62; B60L 53/63; B60L 53/64; H02J 3/32; H02J 103/35

(52) U.S. Cl. CPC B60L 53/62; B60L 53/63; B60L 53/64; H02J 3/32; H02J 2103/35

(57) ABSTRACT

The present invention provides a multi-application scenario-oriented method and system for regulating electric automobile charging loads. In different application scenarios, appropriate electric automobile charging loads are selected for optimized combination and coordinated regulation, so that the system for regulating the electric automobile charging loads can respond quickly and accurately to a power grid dispatching instruction while further ensuring overall economy and safety of the system for regulating the electric automobile charging loads.

### CROSS-REFERENCE TO RELATED APPLICATIONS

The present application is a continuation of International Application No. PCT/CN2024/104107, filed on Jul. 6, 2024, which claims priority to Chinese Patent Application No. 202311810387.2, filed on Dec. 26, 2023, the entire disclosure of which is incorporated herein by reference.

### TECHNICAL FIELD

The present invention relates to the technical field of intelligent electric automobile charging, and in particular to a multi-application scenario-oriented method and system for regulating electric automobile charging loads.

### BACKGROUND

With the society-wide deployment and advancement of the carbon peak and carbon neutrality strategy, the power industry, as one of the core industries of carbon emissions, has proposed a medium- to long-term development path for building a power system centered on new energy. Through large-scale and all-round construction of a new power system, it is resolutely implementing the dual-carbon goal, resulting in a significant increase in proportion of new energy consumption and further acceleration of a decarbonization process. However, randomness and volatility of the new energy aggravate instability of the power system, and gradual replacement of thermal power units by new energy units significantly reduces inertia of the power system, making the power system gradually difficult to cope with frequent disturbances of various types across the power system. Therefore, there is an urgent need for more flexible resources participating in power grid balance and regulation. Electric automobiles are widely distributed and highly flexible, and have a certain degree of regulation ability. If they can be guided to assist power system in running or participating in power market transactions through incentives and other means, it can effectively alleviate a pressure of power grid regulation and support safe and stable running of the power system.

Different application scenarios have different requirements for running of the electric automobile charging loads. For example, a frequency modulation scenario requires an electric automobile charging load with a fast response speed and high charging efficiency to participate in, while electric energy interaction is more related to a charging capacity. Therefore, how to selected an appropriate electric automobile charging load for optimized combination and coordinated regulation in different application scenarios, making the system for regulating the electric automobile charging loads respond quickly and accurately to a power grid dispatching instruction while further ensuring overall economy and safety of the system for regulating the electric automobile charging loads is a problem needing to be solved urgently of a current system for regulating the electric automobile charging loads during coordinated regulation of large-scale electric automobile charging loads.

### SUMMARY

An objective of the present invention is to provide a multi-application scenario-oriented method and system for regulating electric automobile charging loads, so as to solve the problem above-mentioned in the background.

The present invention is implemented by the following technical solutions:

A multi-application scenario-oriented method for regulating electric automobile charging loads is provided, including the following steps:
step S1: identifying, according to market participation of a system for flexibly regulating electric automobile charging loads and a dispatching instruction issued by a power grid, application scenarios for the system for regulating the electric automobile charging loads by means of an application scenario identification module, outputting an identification result, and formulating a three-level regulation system architecture;
step S2: balancing, with charging efficiency, charging durations, charging capacities, and response rates of the electric automobiles as key indicators for a membership function, a relative importance of multiple indicators by introducing an entropy weight method, and performing calculation to obtain a clustering result of the electric automobile charging loads under multiple indicators to achieve cluster division on the electric automobile charging loads;
step S3: performing, according to the application scenario identification result and a cluster division result, application scenario requirement matching;
step S4: selecting, according to the application scenario and a power grid capacity requirement, a most appropriate cluster, wherein in a case that the most appropriate cluster is capable of meeting the capacity requirement of the application scenario, an optimized coordinated regulation model with a lowest regulation cost and a best SOC as objective functions is constructed;
step S5: making, if the most appropriate cluster is not capable of meeting the capacity requirement of the application scenario, the system automatically extend to a second most appropriate cluster, and so on, until the capacity requirement of the application scenario is met, and constructing the optimized coordinated regulation model as in step S4 in a last electric automobile charging load cluster meeting the capacity requirement; and
step S6: selecting, according to the optimized coordinated regulation model, the appropriate electric automobile charging load.

Specifically, there are three application scenarios including peak regulation in a power system, power system frequency regulation and electric energy interaction.

Specifically, the three-level regulation system architecture includes three levels; a first level is a system platform for flexibly regulating the electric automobile charging loads, used for receiving the dispatching instruction issued by the power grid, and distributing the instruction for next-level regulation according to the application scenario matching module; a second level is a cluster division and matching level, used for performing cluster division on all electric automobiles in the system for flexibly regulating the electric automobile charging loads, and performing matching to obtain the most appropriate cluster according to the corresponding scenario; and a third level is a dispatching instruction decomposition level, used for decomposing the power grid dispatching instruction in the appropriate cluster.

Specifically, step S2 includes:
step S2.1: sorting and normalizing raw data of an electric automobile charging load information acquisition module, extracting the indicators of the electric automobiles including the charging efficiency, the charging durations, the charging capacities, and the response rates, and calculating the relative importances of different indicators by using the entropy weight method;
step S2.2: accurately clustering, according to the calculation results of different indicator weights, different electric automobile charging loads by using an improved fuzzy C-means clustering method to distinguish similarities and differences from the charging load samples to different centroid; and
step S2.3: dynamically correcting, according to the application scenario identification result, cluster division on the electric automobile charging loads in real time.

Specifically, a specific process of step S2.1 is as follows:
data of the indicators of the electric automobiles including the charging efficiency, the charging durations, the charging capacities, and the response rates is extracted from the electric automobile charging load information acquisition module, wherein the data is specifically expressed as:

F={η,T,R,S}
wherein F expresses an electric automobile charging load clustering indicator set; expresses an electric automobile charging load charging efficiency indicator; T expresses an electric automobile charging load charging duration indicator; R expresses an electric automobile charging load charging capacity indicator; and S expresses an electric automobile charging load response rate indicator;
the raw data of different indicators of the electric automobile charging loads may be expressed by a matrix as follows:

$$B = [ \begin{matrix}{b}_{11} & … & … & {b}_{1 N} \\ {b}_{21} & … & … & {b}_{2 N} \\ ⋮ & ⋮ & ⋮ & ⋮ \\ {b}_{M 1} & … & … & {b}_{M N}\end{matrix} ]$$

wherein M expresses a quantity of the electric automobile charging loads; N expresses a quantity of clustering indicators; B is relative importance for quantifying different indicators for calculation on various indicator weights by using the entropy weight method, specifically as follows:

$${p}_{m n} = \frac{{z}_{m n}}{{\sum }_{m = 1}^{M} {z}_{m n}}$$

$${e}_{n} = − \frac{1}{ln M} {\sum }_{m = 1}^{M} {p}_{m n} ln ( {p}_{m n} )$$

$${ω}_{n} = \frac{1 − {e}_{n}}{{\sum }_{n = 1}^{N} 1 − {e}_{n}}$$

Wherein zₘₙ expresses data obtained by normalizing raw data bₘₙ of an n^{th} clustering indicator of an m^{th} electric automobile charging load; pₘₙ expresses a proportion of the n^{th} clustering indicator of the m^{th} electric automobile charging load; eₙ expresses an information entropy value of the n^{th} clustering indicator of the electric automobile charging load; and ωₙ expresses a weight of the n^{th} clustering indicator of the electric automobile charging load; and
in this case, a comprehensive clustering indicator of the m^{th} electric automobile charging load may be expressed as:

ωₙ={ω₁,ω₂,ω₃,ω₄}

Cₘ=ω₁ηₘ+ω₂Tₘ+ω₃Rₘ+ω₄Sₘ
wherein ω₁, ω₂, ω₃, and express indicator weights of the electric automobile charging load including the charging efficiency, the charging duration, the charge capacity, and the response rate respectively; cₘ expresses the comprehensive clustering indicator of the m^{th} electric automobile charging load; ηᵢ expresses the charging efficiency of the m^{th} electric automobile charging load; Tₘ expresses the charging duration of the m^{th} electric automobile charging load; Rₘ expresses the charging capacity of the m^{th} electric automobile charging load; and s expresses the response rate of the m^{th} electric automobile charging load.

Specifically, a specific process of step S2.2 is as follows:
the electric automobile charging loads is clustered, and cluster division is performed by using the improved fuzzy C-means clustering method, specifically comprising:
first, calculating centroid cₘⱼ of different clusters by means of the following formula:

$${c}_{m j} = {min}_{m ∈ [ 1 , M ]} \{ \frac{{r}^{3} π}{A {\sum }_{m = 1}^{M} {( \frac{{b}_{n N} − {b}_{m N}}{2} )}^{\frac{7}{3}} {π}^{3} + 2} \}$$

$$r = \frac{4}{j [ {( M − 0.5 )}^{\frac{7}{3}} − \frac{3}{2} ]} {\sum }_{m}^{M} {\sum }_{n}^{N} {‖ {d}_{m} − {d}_{n} ‖}^{\frac{3}{2}}$$

wherein r is a neighborhood radius; j is a quantity of the clusters; and A is a quantity of samples within the neighborhood radius;
second, initializing a membership matrix U, and performing a t^{th} iterative update to obtain a membership matrix as follows:

$${U}_{t} \{ {u}_{mj} \}$$

$${u}_{mj}^{t} = \frac{1}{{\sum }_{g = 1}^{j} {[ \frac{{‖ {C}_{m} − {C}_{m}^{t} ‖}^{\frac{7}{3}}}{{‖ {C}_{m} − {C}_{m g}^{t} ‖}^{\frac{7}{3}}} ]}^{\frac{2}{m - 2}}}$$

wherein uₘⱼ^{t} expresses a degree of membership of the t^{th} electric automobile charging load, subjected to a m^{th} iteration, belonging to a j^{th} cluster; Cₘⱼ^{t} expresses a distance from the t^{th} electric automobile charging load to centroid of the m^{th} cluster after the j^{th} iteration; and C_{mg}^{t} expresses a distance from the t^{th} electric automobile charging load to centroid of a m^{th} cluster after the g^{th} iteration, wherein
   a centroid matrix after the t^{th} iterative update is as follows:

$${c}_{m j}^{t} = \frac{{\sum }_{m = 1}^{M} K \frac{{C}_{m}}{{\sum }_{g = 1}^{j} {[ \frac{{‖ {C}_{m} − {C}_{m}^{t} ‖}^{\frac{7}{3}}}{{‖ {C}_{m} − {C}_{m g}^{t} ‖}^{\frac{7}{3}}} ]}^{\frac{2}{m - 2}}}}{{\sum }_{m = 1}^{M} K {u}_{mj}^{t}}$$

$$K = {[ \frac{{\prod }_{g = 1}^{j} {‖ {C}_{m} − {C}_{m g}^{t} ‖}^{\frac{2}{ω − 2}}}{{\sum }_{g = 1}^{j} {\prod }_{g = 1}^{j} {‖ {C}_{m} − {C}_{mg}^{t} ‖}^{\frac{1}{ω − 1}}} ]}^{\frac{2 ω}{5}}$$

wherein cₘⱼ^{t} expresses the distance from the m^{th} electric automobile charging load to centroid of the j^{th} cluster after the t^{th} iteration; and K expresses a proportionality coefficient; and
third, terminating the iteration if either a quantity of iterations reaches a preset number of termination or

$$\vert {u}_{mj}^{t} - {u}_{mj}^{t - 1} \vert \leq ξ$$

(ξ expresses an infinitesimal value) and outputting a calculation result; otherwise, returning to the second step for a next iteration.

Specifically, a specific process of step S2.3 is as follows:
cluster division of the electric automobile charging loads is corrected by updating calculation results of different indicator weights by means of combining artificial setting with the entropy weight method, and artificial setting is performed according to different application scenarios, specifically as follows:

$$ω = \{ \begin{matrix}{ω}_{1} - 0.5 & peak regulation in a power system \\ {ω}_{4} - 0.5 & power system frequency regulation \\ No artificial setting & electric energy interaction\end{matrix}$$

after artificial setting of a part of indicators for specified scenarios, remaining indicators are recalculated by using the entropy weight method in step S2.1, to update the calculation results of various indicator weights, and then cluster division results are updated accordingly.

Specifically, a specific process of step S4 is as follows:
a calculating formula of the lowest regulation cost as a objective function is as follows:

$${F}_{1} = min \{ {\sum }_{h = 1}^{H} {\sum }_{t = 1}^{T} {r}_{h}^{t} ⋆ {p}^{t} \}$$

wherein F₁ is the lowest regulation cost as the objective function; rₕ^{t} expresses a charging capacity of an h^{th} electric automobile charging load of the most appropriate cluster during a time period t; p^{t} expresses a charging price of the electric automobile charging load during the time period t; T expresses a total quantity of time periods; and H expresses a total quantity of the electric automobile charging loads included in the most appropriate cluster;
a calculating formula of the best SOC as a objective function of the electric automobile charging load is as follows:

$${F}_{2} = min \vert {SOC}_{h}^{t} - {SOC}_{ideal} \vert$$

wherein F₂ is the best SOC as the objective function of the electric automobile charging load; rₕ^{t} expresses a state of charge (SOC) value of the h^{th} electric automobile charging load of the most appropriate cluster during the time period t; and p^{t} expresses a best SOC value of the electric automobile charging load; and
the optimized coordinated regulation model for the electric automobile charging load may be expressed as follows:

F=αF₁f+(1−α)F₂
wherein α expresses a coordination coefficient.

A multi-application scenario-oriented system for regulating electric automobile charging loads is applied to the multi-application scenario-oriented method for regulating the electric automobile charging loads, where the system includes an application scenario identification module, a charging load dynamic clustering module, an application scenario matching module, a charging load information acquisition module, and a charging load control module, where
the application scenario identification module is used for analyzing types of electric power market transaction in which the electric automobile charging loads participate and dispatching instructions issued by a power grid, judging specific application scenarios where the system for regulating the electric automobile charging loads interact with the power grid in the future, and uploading a judgment result to the application scenario matching module;
the charging load dynamic clustering module is used for performing cluster division on the electric automobile charging loads according to clustering indicators such as charging durations, charging capacities, charging efficiency, and response rates, and uploading a clustering result to the application scenario matching module;
the application scenario matching module is used for selecting a most appropriate cluster for the system for flexibly regulating the electric automobile charging loads for application scenario requirement matching according to an application scenario identification result and a clustering result of the electric automobile charging loads;
the charging load information acquisition module is used for acquiring and monitoring information related to running states of the electric automobile charging loads, and uploading data to the application scenario identification module, the charging load dynamic clustering module, and the charging load control module; and
the charging load control module is used for receiving a charging instruction decomposed by the system for regulating the electric automobile charging loads, performing charging control on the electric automobile charging loads, and sensing states of charging processes of the electric automobile charging loads according to running data uploaded by the charging load information acquisition module.

Compared with the prior art, the present invention has the beneficial effects that:

The present invention provides the multi-application scenario-oriented system and method for regulating the electric automobile charging loads. In different application scenarios, appropriate electric automobile charging loads are selected for optimized combination and coordinated regulation, so that the system for regulating the electric automobile charging loads can respond quickly and accurately to a power grid dispatching instruction while further ensuring overall economy and safety of the system for regulating the electric automobile charging loads.

### BRIEF DESCRIPTION OF DRAWINGS

In order to more clearly describe the technical solutions of the embodiments of the present invention, the accompanying drawings required to describe the embodiments are briefly described below. Apparently, the accompanying drawings described below are only preferred embodiments of the present invention. Those of ordinary skill in the art may further obtain other accompanying drawings based on these accompanying drawings without inventive effort.

FIG. 1 is a flowchart of steps of a multi-application scenario-oriented method for regulating electric automobile charging loads provided by the present invention; and

FIG. 2 is a structural diagram of a multi-application scenario-oriented system for regulating electric automobile charging loads provided by the present invention.

### DETAILED DESCRIPTION OF THE EMBODIMENTS

To make objectives, technical solutions and advantages of the present invention more obvious, the exemplary embodiments of the present invention are described in detail below in conjunction with the accompanying drawings. Apparently, the embodiments described are merely some embodiments rather than all embodiments of the present invention. It should be understood that, the present invention is not limited to the exemplary embodiments described herein. Based on the described embodiments of the present invention, all other embodiments obtained by those skilled in the art without creative efforts shall fall within the protection scope of the present invention.

In the following description, numerous specific details are given to provide a more thorough understanding of the present invention. However, it will be apparent to those skilled in the art that the present invention may be implemented without one or more of these details. In other examples, to avoid confusion with the present invention, some technical features well known in the art are not described.

It should be understood that the present invention can be implemented in different forms and should not be construed as being limited to the embodiments presented herein. Rather, these embodiments are provided so that this disclosure will be thorough and complete, and will fully convey the scope of the present invention to those skilled in the art.

The purpose of using terms herein is merely for describing the specific embodiments and is not for limiting the present invention. When used herein, the “one”, “one piece”, and “the/said” in singular forms are also intended to include plural forms, unless other manners are clearly indicated in the context. It should also be understood that when the terms “composition” and/or “including” are used in the specification, the presence of the features, integers, steps, operations, elements, and/or components is determined, but does not exclude the presence or addition of one or more other features, integers, steps, operations, elements, components, and/or groups. When used herein, the term “and/or” includes any and all combinations of the listed items.

For a thorough understanding of the present invention, detailed structures will be provided in the following description to explain the technical solutions proposed by the present invention. The optional embodiment of the present invention is described in detail below, but in addition to the detailed description, the present invention also may have other implementations.

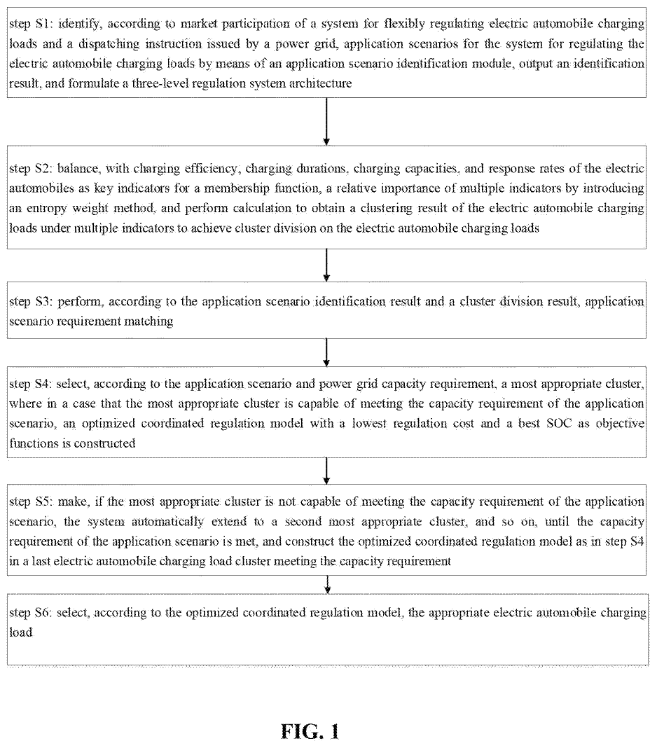

Referring to FIG. 1, in a first aspect of the present invention, a multi-application scenario-oriented method for regulating electric automobile charging loads is provided, including the following steps:
step S1: identifying, according to market participation of a system for flexibly regulating electric automobile charging loads and a dispatching instruction issued by a power grid, application scenarios for the system for regulating the electric automobile charging loads by means of an application scenario identification module, outputting an identification result, and formulating a three-level regulation system architecture;
step S2: balancing, with charging efficiency, charging durations, charging capacities, and response rates of the electric automobiles as key indicators for a membership function, a relative importance of multiple indicators by introducing an entropy weight method, and performing calculation to obtain a clustering result of the electric automobile charging loads under multiple indicators to achieve cluster division on the electric automobile charging loads;
step S3: performing, according to the application scenario identification result and a cluster division result, application scenario requirement matching;
step S4: selecting, according to the application scenario and a power grid capacity requirement, a most appropriate cluster, where in a case that the most appropriate cluster is capable of meeting the capacity requirement of the application scenario, an optimized coordinated regulation model with a lowest regulation cost and a best SOC as objective functions is constructed; and economy and safety of the system for flexibly regulating the electric automobile charging loads are ensured while meeting the capacity requirement of the application scenario;
step S5: making, if the most appropriate cluster is not capable of meeting the capacity requirement of the application scenario, the system automatically extend to a second most appropriate cluster, and so on, until the capacity requirement of the application scenario is met, and constructing the optimized coordinated regulation model as in step S4 in a last electric automobile charging load cluster meeting the capacity requirement; and
step S6: selecting, according to the optimized coordinated regulation model, the appropriate electric automobile charging load.

Specifically, there are three application scenarios including peak regulation in a power system, power system frequency regulation and electric energy interaction.

Specifically, the three-level regulation system architecture includes three levels; a first level is a system platform for flexibly regulating the electric automobile charging loads, used for receiving the dispatching instruction issued by the power grid, and distributing the instruction for next-level regulation according to the application scenario matching module; a second level is a cluster division and matching level, used for performing cluster division on all electric automobiles in the system for flexibly regulating the electric automobile charging loads, and performing matching to obtain the most appropriate cluster according to the corresponding scenario; and a third level is a dispatching instruction decomposition level, used for decomposing the power grid dispatching instruction in the appropriate cluster.

Specifically, step S2 includes:
step S2.1: sorting and normalizing raw data of an electric automobile charging load information acquisition module, extracting the indicators of the electric automobiles including the charging efficiency, the charging durations, the charging capacities, and the response rates, and calculating the relative importances of different indicators by introducing the entropy weight method;
step S2.2: accurately clustering, according to the calculation results of different indicator weights, different electric automobile charging loads by using an improved fuzzy C-means clustering method to distinguish similarities and differences from the charging load samples to different centroid; and
step S2.3: dynamically correcting, according to the application scenario identification result, cluster division on the electric automobile charging loads in real time.

Specifically, a specific process of step S2.1 is as follows:
data of the indicators of the electric automobiles including the charging efficiency, the charging durations, the charging capacities, and the response rates is extracted from the electric automobile charging load information acquisition module, wherein the data is specifically expressed as:

F={η, T, R, S}

Wherein F expresses an electric automobile charging load clustering indicator set; η expresses an electric automobile charging load charging efficiency indicator; T expresses an electric automobile charging load charging duration indicator; R expresses an electric automobile charging load charging capacity indicator; and S expresses an electric automobile charging load response rate indicator;
the raw data of different indicators of the electric automobile charging loads may be expressed by a matrix as follows:

$$B = [ \begin{matrix}{b}_{11} & … & … & {b}_{1 N} \\ {b}_{21} & … & … & {b}_{2 N} \\ ⋮ & ⋮ & ⋮ & ⋮ \\ {b}_{M 1} & … & … & {b}_{MN}\end{matrix} ]$$

wherein M expresses a quantity of the electric automobile charging loads; N expresses a quantity of clustering indicators; B is relative importance for quantifying different indicators for calculation on various indicator weights by using the entropy weight method, specifically as follows:

$${p}_{m n} = \frac{{z}_{m n}}{{\sum }_{m = 1}^{M} {z}_{m n}}$$

$${e}_{n} = − \frac{1}{ln M} {\sum }_{m = 1}^{M} {p}_{m n} ln ( {p}_{m n} )$$

$${ω}_{n} = \frac{1 − {e}_{n}}{{\sum }_{n = 1}^{N} 1 − {e}_{n}}$$

Wherein zₘₙ expresses data obtained by normalizing raw data bₘₙ of an n^{th} clustering indicator of an m^{th} electric automobile charging load; pₘₙ expresses a proportion of the n^{th} clustering indicator of the m^{th} electric automobile charging load; eₙ expresses an information entropy value of the n^{th} clustering indicator of the electric automobile charging load; and ωₙ expresses a weight of the n^{th} clustering indicator of the electric automobile charging load; and in this case, a comprehensive clustering indicator of the m^{th} electric automobile charging load may be expressed as:

ωₙ={ω₁,ω₂,ω₃,ω₄}

Cₘ=ω₁ηₘ+ω₂Tₘ+ω₃Rₘ+ω₄Sₘ
wherein ω₁, ω₂, ω₃, and express indicator weights of the electric automobile charging load including the charging efficiency, the charging duration, the charge capacity, and the response rate respectively; Cₘ expresses the comprehensive clustering indicator of the m^{th} electric automobile charging load; ηᵢ expresses the charging efficiency of the m^{th} electric automobile charging load; Tₘ expresses the charging duration of the m^{th} electric automobile charging load; Rₘ expresses the charging capacity of the m^{th} electric automobile charging load; and Sₘ expresses the response rate of the m^{th} electric automobile charging load.

Specifically, a specific process of step S2.2 is as follows:
the electric automobile charging loads is clustered, and cluster division is performed by using the improved fuzzy C-means clustering method, specifically comprising:
first, calculating centroid cₘⱼ of different clusters by means of the following formula:

$${c}_{m j} = {min}_{m ∈ [ 1 , M ]} \{ \frac{{r}^{3} π}{A {\sum }_{m = 1}^{M} {( \frac{{b}_{n N} − {b}_{m N}}{2} )}^{\frac{7}{3}} {π}^{3} + 2} \}$$

$$r = \frac{4}{j [ {( M − 0.5 )}^{\frac{7}{3}} − \frac{3}{2} ]} {\sum }_{m}^{M} {\sum }_{n}^{N} {‖ {d}_{m} − {d}_{n} ‖}^{\frac{3}{2}}$$

where r is a neighborhood radius; j is a quantity of the clusters; and A is a quantity of samples within the neighborhood radius;
second, initializing a membership matrix U, and performing a t^{th} iterative update to obtain a membership matrix as follows:

$${U}_{t} = \{ {u}_{mj} \}$$

$${u}_{mj}^{t} = \frac{1}{{\sum }_{g = 1}^{j} {[ \frac{{‖ {C}_{m} - {C}_{mj}^{t} ‖}^{\frac{7}{3}}}{{‖ {C}_{m} - {C}_{m g}^{t} ‖}^{\frac{7}{3}}} ]}^{\frac{2}{m - 2}}}$$

where uₘⱼ^{t} expresses a degree of membership of the m^{th} electric automobile charging load, subjected to a t^{th} iteration, belonging to a j^{th} cluster, uₘⱼϵ[0,1]; Cₘⱼ^{t} expresses a distance from the m^{th} electric automobile charging load to centroid of the j^{th} cluster after the t^{th} iteration; and C_{mg}^{t} expresses a distance from the m^{th} electric automobile charging load to centroid of a g^{th} cluster after the t^{th} iteration, gϵ[1,j], where
a centroid matrix after the t^{th} iterative update is as follows:

$${c}_{mj}^{t} = \frac{{\sum }_{m = 1}^{M} K \frac{{C}_{m}}{{\sum }_{g = 1}^{j} {[ \frac{{‖ {C}_{m} - {C}_{mj}^{t} ‖}^{\frac{7}{3}}}{{‖ {C}_{m} - {C}_{m g}^{t} ‖}^{\frac{7}{3}}} ]}^{\frac{2}{m - 2}}}}{{\sum }_{m = 1}^{M} {Ku}_{mj}^{t}}$$

$$K = {[ \frac{{{\prod }_{g = 1}}^{j} {‖ {C}_{m} - {C}_{m g}^{t} ‖}^{\frac{2}{ω - 2}}}{{\sum }_{g = 1}^{j} {{\prod }_{g = 1}}^{j} {‖ {C}_{m} - {C}_{m g}^{t} ‖}^{\frac{1}{ω - 1}}} ]}^{\frac{2 ω}{5}}$$

where cₘⱼ^{t} expresses the distance from the m^{th} electric automobile charging load to centroid of the j^{th} cluster after the t^{th} iteration; and K expresses a proportionality coefficient; and
third, terminating the iteration if either a quantity of iterations reaches a preset number of termination or

$$\vert {u}_{mj}^{t} - {u}_{mj}^{t - 1} \vert \leq ξ$$

(ξ expresses an infinitesimal value) and giving an a calculation result; otherwise, returning to the second step for a next iteration.

Specifically, a specific process of step S2.3 is as follows:

Considering obvious differences between the electric automobile charging loads with different charging characteristics in preference level in different application scenarios, cluster division of the electric automobile charging loads is corrected by updating calculation results of different indicator weights by means of combining artificial setting with the entropy weight method, and artificial setting is performed according to different application scenarios, specifically as follows:

$$ω = \{ \begin{matrix}{ω}_{1} = 0.5 & peak regulation in a power system \\ {ω}_{4} = 0.5 & power system frequency regulation \\ No artificial setting & electric energy interaction\end{matrix}$$

after artificial setting of a part of indicators for specified scenarios, remaining indicators are recalculated by using the entropy weight method in step S2.1, to update the calculation results of various indicator weights, and then cluster division results are updated accordingly.

Specifically, a specific process of step S4 is as follows:
a calculating formula of the lowest regulation cost as a objective function is as follows:

$${F}_{1} = min \{ {\sum }_{h = 1}^{H} {\sum }_{t = 1}^{T} {r}_{h}^{t} * {p}^{t} \}$$

where F₁ is the lowest regulation cost as the objective function; rₕ^{t} expresses a charging capacity of an h^{th} electric automobile charging load of the most appropriate cluster during a time period t; p^{t} expresses a charging price of the electric automobile charging load during the time period t; T expresses a total quantity of time periods, with a time interval being 15 min, T=96; and H expresses a total quantity of the electric automobile charging loads included in the most appropriate cluster;
a calculating formula of the best SOC as a objective function of the electric automobile charging load is as follows:

$${F}_{2} = min \vert {SOC}_{h}^{t} - {SOC}_{ideal} \vert$$

wherein F₂ is the best SOC as the objective function of the electric automobile charging load; rₕ^{t} expresses a state of charge (SOC) value of the h^{th} electric automobile charging load of the most appropriate cluster during the time period t; and p^{t} expresses a best SOC value of the electric automobile charging load; and
the optimized coordinated regulation model for the electric automobile charging load may be expressed as follows:

F=αF₁+(1−α)F₂

wherein α expresses a coordination coefficient.

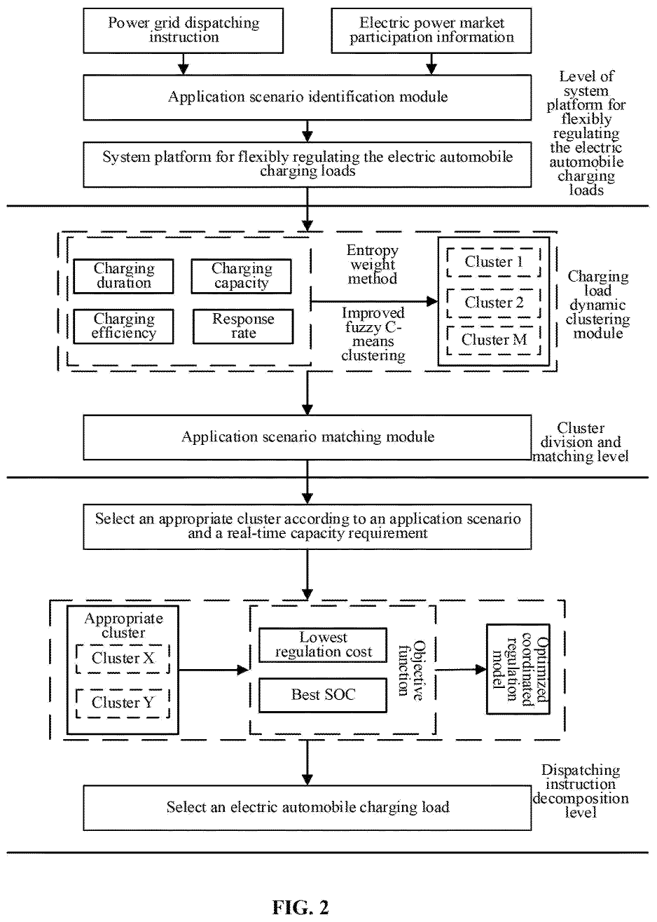

Referring to FIG. 2, in a second aspect of the present invention, a multi-application scenario-oriented system for regulating electric automobile charging loads is provided, applied to the multi-application scenario-oriented method for regulating the electric automobile charging loads, where the system includes an application scenario identification module, a charging load dynamic clustering module, an application scenario matching module, a charging load information acquisition module, and a charging load control module, where
the application scenario identification module is used for analyzing types of electric power market transaction in which the electric automobile charging loads participate and dispatching instructions issued by a power grid, judging specific application scenarios where the system for regulating the electric automobile charging loads interact with the power grid in the future, and uploading a judgment result to the application scenario matching module;
the charging load dynamic clustering module is used for performing cluster division on the electric automobile charging loads according to clustering indicators such as charging durations, charging capacities, charging efficiency, and response rates, and uploading a clustering result to the application scenario matching module;
the application scenario matching module is used for selecting a most appropriate cluster for the system for flexibly regulating the electric automobile charging loads for application scenario requirement matching according to an application scenario identification result and a clustering result of the electric automobile charging loads;
the charging load information acquisition module is used for acquiring and monitoring information related to running states of the electric automobile charging loads, and uploading data to the application scenario identification module, the charging load dynamic clustering module, and the charging load control module; and
the charging load control module is used for receiving a charging instruction decomposed by the system for regulating the electric automobile charging loads, performing charging control on the electric automobile charging loads, and sensing states of charging processes of the electric automobile charging loads according to running data uploaded by the charging load information acquisition module.

The above descriptions are only preferred embodiments of the present invention, and are not intended to limit the present invention. Any modifications, equivalent replacements, etc. made within the spirit and principles of the present invention shall be included in the protection scope of the present invention.

What is claimed is:

1. A multi-application scenario-oriented method for regulating electric automobile charging loads, comprising the following steps:
step S1: identifying, according to market participation of a system for flexibly regulating electric automobile charging loads and a dispatching instruction issued by a power grid, application scenarios for the system for regulating the electric automobile charging loads by means of an application scenario identification module, outputting an identification result, and formulating a three-level regulation system architecture;
step S2: balancing, with charging efficiency, charging durations, charging capacities, and response rates of the electric automobiles as key indicators for a membership function, a relative importance of multiple indicators by introducing an entropy weight method, and performing calculation to obtain a clustering result of the electric automobile charging loads under multiple indicators to achieve cluster division on the electric automobile charging loads;
step S3: performing, according to the application scenario identification result and a cluster division result, application scenario requirement matching;
step S4: selecting, according to the application scenario and a power grid capacity requirement, a most appropriate cluster, wherein in a case that the most appropriate cluster is capable of meeting the capacity requirement of the application scenario, an optimized coordinated regulation model with a lowest regulation cost and a best SOC as objective functions is constructed;
step S5: making, if the most appropriate cluster is not capable of meeting the capacity requirement of the application scenario, the system automatically extend to a second most appropriate cluster, and so on, until the capacity requirement of the application scenario is met, and constructing the optimized coordinated regulation model as in step S4 in a last electric automobile charging load cluster meeting the capacity requirement; and
step S6: selecting, according to the optimized coordinated regulation model, the appropriate electric automobile charging load.

2. The multi-application scenario-oriented method for regulating electric automobile charging loads according to claim 1, wherein there are three application scenarios comprising peak regulation in a power system, power system frequency regulation and electric energy interaction.

3. The multi-application scenario-oriented method for regulating electric automobile charging loads according to claim 1, wherein the three-level regulation system architecture comprises three levels; a first level is a system platform for flexibly regulating the electric automobile charging loads, used for receiving the dispatching instruction issued by the power grid, and distributing the instruction for next-level regulation according to the application scenario matching module; a second level is a cluster division and matching level, used for performing cluster division on all electric automobiles in the system for flexibly regulating the electric automobile charging loads, and performing matching to obtain the most appropriate cluster according to the corresponding scenario; and a third level is a dispatching instruction decomposition level, used for decomposing the power grid dispatching instruction in the appropriate cluster.

4. The multi-application scenario-oriented method for regulating the electric automobile charging loads according to claim 1, wherein step S2 specifically comprises:
step S2.1: sorting and normalizing raw data of an electric automobile charging load information acquisition module, extracting the indicators of the electric automobiles including the charging efficiency, the charging durations, the charging capacities, and the response rates, and calculating the relative importances of different indicators by using the entropy weight method;
step S2.2: accurately clustering, according to the calculation results of different indicator weights, different electric automobile charging loads by using an improved fuzzy C-means clustering method to distinguish similarities and differences from the charging load samples to different centroid; and
step S2.3: dynamically correcting, according to the application scenario identification result, cluster division on the electric automobile charging loads in real time.

5. The multi-application scenario-oriented method for regulating the electric automobile charging loads according to claim 4, wherein a specific process of step S2.1 is as follows:
data of the indicators of the electric automobiles including the charging efficiency, the charging durations, the charging capacities, and the response rates is extracted from the electric automobile charging load information acquisition module, wherein the data is specifically expressed as:
F={η,T,R,S}
wherein F expresses an electric automobile charging load clustering indicator set; η expresses an electric automobile charging load charging efficiency indicator; T expresses an electric automobile charging load charging duration indicator; R expresses an electric automobile charging load charging capacity indicator; and S expresses an electric automobile charging load response rate indicator;
the raw data of different indicators of the electric automobile charging loads may be expressed by a matrix as follows:
$$B = [ \begin{matrix}{b}_{11} & … & … & {b}_{1 N} \\ {b}_{21} & … & … & {B}_{2 N} \\ ⋮ & ⋮ & ⋮ & ⋮ \\ {b}_{M 1} & … & … & {b}_{MN}\end{matrix} ]$$
wherein M expresses a quantity of the electric automobile charging loads; N expresses a quantity of clustering indicators; B is relative importance for quantifying different indicators for calculation on various indicator weights by using the entropy weight method, specifically as follows:
$${p}_{mn} = \frac{{z}_{mn}}{{\sum }_{m = 1}^{M} {z}_{mn}}$$
$${e}_{n} = - \frac{1}{ln M} {\sum }_{m = 1}^{M} {p}_{mn} ln ( {p}_{mn} )$$
$${ω}_{n} = \frac{1 - {e}_{n}}{{\sum }_{n = 1}^{N} 1 - {e}_{n}}$$
Wherein zₘₙ expresses data obtained by normalizing raw data bₘₙ of an n^{th} clustering indicator of an m^{th} electric automobile charging load; pₘₙ expresses a proportion of the n^{th} clustering indicator of the m^{th} electric automobile charging load; eₙ expresses an information entropy value of the n^{th} clustering indicator of the electric automobile charging load; and ωₙ expresses a weight of the n^{th} clustering indicator of the electric automobile charging load; and
in this case, a comprehensive clustering indicator of the m^{th} electric automobile charging load may be expressed as:
ωₙ={ω₁,ω₂,ω₃,ω₄}
Cₘ=ω₁ηₘ+ω₂Tₘ+ω₃Rₘ+ω₄Sₘ
wherein ω₁, ω₂, ω₃, and ω₄ express indicator weights of the electric automobile charging load including the charging efficiency, the charging duration, the charge capacity, and the response rate respectively; Cₘ expresses the comprehensive clustering indicator of the m^{th} electric automobile charging load; ηᵢ expresses the charging efficiency of the m^{th} electric automobile charging load; Tₘ expresses the charging duration of the m^{th} electric automobile charging load; Rₘ expresses the charging capacity of the m^{th} electric automobile charging load; and Sₘ expresses the response rate of the m^{th} electric automobile charging load.

6. The multi-application scenario-oriented method for regulating the electric automobile charging loads according to claim 5, wherein a specific process of step S2.2 is as follows:
the electric automobile charging loads is clustered, and cluster division is performed by using the improved fuzzy C-means clustering method, specifically comprising:
first, calculating centroid cₘⱼ of different clusters by means of the following formula:
$${c}_{mj} = {min}_{m ∈ [ 1 , M ]} \{ \frac{{r}^{3} π}{A {\sum }_{m = 1}^{M} {( \frac{{b}_{nN} - {b}_{mN}}{2} )}^{\frac{7}{3}} {π}^{3} + 2} \}$$
$$r = \frac{4}{j [ {( M - 0.5 )}^{\frac{7}{3}} - \frac{3}{2} ]} {\sum }_{m}^{M} {\sum }_{n}^{N} {‖ {d}_{m} - {d}_{n} ‖}^{\frac{3}{2}}$$
wherein r is a neighborhood radius; j is a quantity of the clusters; and A is a quantity of samples within the neighborhood radius;
second, initializing a membership matrix U, and performing a t^{th} iterative update to obtain a membership matrix as follows:
$${U}_{t} = \{ {u}_{mj} \}$$
$${u}_{mj}^{t} = \frac{1}{{\sum }_{g = 1}^{j} {[ \frac{{‖ {C}_{m} - {C}_{mj}^{t} ‖}^{\frac{7}{3}}}{{‖ {C}_{m} - {C}_{m g}^{t} ‖}^{\frac{7}{3}}} ]}^{\frac{2}{m - 2}}}$$
wherein uₘⱼ^{t} expresses a degree of membership of the m^{th} electric automobile charging load, subjected to a t^{th} iteration, belonging to a j^{th} cluster; Cₘⱼ^{t} expresses a distance from the m^{th} electric automobile charging load to centroid of the j^{th} cluster after the t^{th} iteration; and C_{mg}^{t} expresses a distance from the m^{th} electric automobile charging load to centroid of a g^{th} cluster after the t^{th} iteration, wherein
a centroid matrix after the t^{th} iterative update is as follows:
$${c}_{mj}^{t} = \frac{{\sum }_{m = 1}^{M} K \frac{{C}_{m}}{{\sum }_{g = 1}^{j} {[ \frac{{‖ {C}_{m} - {C}_{mj}^{t} ‖}^{\frac{7}{3}}}{{‖ {C}_{m} - {C}_{m g}^{t} ‖}^{\frac{7}{3}}} ]}^{\frac{2}{m - 2}}}}{{\sum }_{m = 1}^{M} {Ku}_{mj}^{t}}$$
$$K = {[ \frac{{{\prod }_{g = 1}}^{j} {‖ {C}_{m} - {C}_{m g}^{t} ‖}^{\frac{2}{ω - 2}}}{{\sum }_{g = 1}^{j} {{\prod }_{g = 1}}^{j} {‖ {C}_{m} - {C}_{m g}^{t} ‖}^{\frac{1}{ω - 1}}} ]}^{\frac{2 ω}{5}}$$
wherein cₘⱼ^{t} expresses the distance from the m^{th} electric automobile charging load to centroid of the j^{th} cluster after the t^{th} iteration; and K expresses a proportionality coefficient; and
third, terminating the iteration if either a quantity of iterations reaches a preset number of termination or
$$\vert {u}_{mj}^{t} - {u}_{mj}^{t - 1} \vert \leq ξ$$
(ξ expresses an infinitesimal value) and outputting a calculation result; otherwise, returning to the second step for a next iteration.

7. The multi-application scenario-oriented method for regulating the electric automobile charging loads according to claim 6, wherein a specific process of step S2.3 is as follows:
cluster division of the electric automobile charging loads is corrected by updating calculation results of different indicator weights by means of combining artificial setting with the entropy weight method, and artificial setting is performed according to different application scenarios, specifically as follows:
$$ω = \{ \begin{matrix}{ω}_{1} = 0.5 & peak regulation in a power system \\ {ω}_{4} = 0.5 & power system frequency regulation \\ No artificial setting & electric energy interaction\end{matrix}$$
after artificial setting of a part of indicators for specified scenarios, remaining indicators are recalculated by using the entropy weight method in step S2.1, to update the calculation results of various indicator weights, and then cluster division results are updated accordingly.

8. The multi-application scenario-oriented method for regulating the electric automobile charging loads according to claim 1, wherein a specific process of step S4 is as follows:
a calculating formula of the lowest regulation cost as a objective function is as follows:
$${F}_{1} = min \{ {\sum }_{h = 1}^{H} {\sum }_{t = 1}^{T} {r}_{h}^{t} * {p}^{t} \}$$
wherein F₁ is the lowest regulation cost as the objective function; rₕ^{t} expresses a charging capacity of an h^{th} electric automobile charging load of the most appropriate cluster during a time period t; p^{t} expresses a charging price of the electric automobile charging load during the time period t; T expresses a total quantity of time periods; and H expresses a total quantity of the electric automobile charging loads included in the most appropriate cluster;
a calculating formula of the best SOC as a objective function of the electric automobile charging load is as follows:
$${F}_{2} = min \vert {SOC}_{h}^{t} - {SOC}_{ideal} \vert$$
wherein F₂ is the best SOC as the objective function of the electric automobile charging load; rₕ^{t} expresses a state of charge (SOC) value of the h^{th} electric automobile charging load of the most appropriate cluster during the time period t; and p^{t} expresses a best SOC value of the electric automobile charging load; and
the optimized coordinated regulation model for the electric automobile charging load may be expressed as follows:
F=αF₁+(1−α)F₂
wherein α expresses a coordination coefficient.

9. A multi-application scenario-oriented system for regulating electric automobile charging loads, applied to the multi-application scenario-oriented method for regulating the electric automobile charging loads according to claim 1, wherein the system comprises an application scenario identification module, a charging load dynamic clustering module, an application scenario matching module, a charging load information acquisition module, and a charging load control module, wherein
the application scenario identification module is used for analyzing types of electric power market transaction in which the electric automobile charging loads participate and dispatching instructions issued by a power grid, judging specific application scenarios where the system for regulating the electric automobile charging loads interact with the power grid in the future, and uploading a judgment result to the application scenario matching module;
the charging load dynamic clustering module is used for performing cluster division on the electric automobile charging loads according to clustering indicators such as charging durations, charging capacities, charging efficiency, and response rates, and uploading a clustering result to the application scenario matching module;
the application scenario matching module is used for selecting a most appropriate cluster for the system for flexibly regulating the electric automobile charging loads for application scenario requirement matching according to an application scenario identification result and a clustering result of the electric automobile charging loads;
the charging load information acquisition module is used for acquiring and monitoring information related to running states of the electric automobile charging loads, and uploading data to the application scenario identification module, the charging load dynamic clustering module, and the charging load control module; and
the charging load control module is used for receiving a charging instruction decomposed by the system for regulating the electric automobile charging loads, performing charging control on the electric automobile charging loads, and sensing states of charging processes of the electric automobile charging loads according to running data uploaded by the charging load information acquisition module.
